(19) United States
(12) Patent Application Publication
(10) Pub. No.: US 2014/0122178 A1
(43) Pub. Date: May 1, 2014

(54) METHOD FOR OPTIMIZING NEW VEHICLE INVENTORY FOR A CAR DEALERSHIP

(71) Applicants: Barnaby St. John Knight, Amersham (GB); Stephen Shaw, Newtonabbey (GB)

(72) Inventors: Barnaby St. John Knight, Amersham (GB); Stephen Shaw, Newtonabbey (GB)

(21) Appl. No.: 14/067,348

(22) Filed: Oct. 30, 2013

Related U.S. Application Data
(60) Provisional application No. 61/719,987, filed on Oct. 30, 2012.

(51) Int. Cl. G06Q 30/02

(52) U.S. Cl. CPC G06Q 30/0202
USPC 705/7.31

(57) ABSTRACT

A computer implemented method for optimizing automobile dealer inventory includes determining at least one future purchase intention metric for a catchment area in which a dealer is located, determining expected future retail sales of a vehicle type based on the determined future purchase intention metric, comparing the expected future retail sales of the vehicle type to an expected inventory of the vehicle type for at least one time period, and outputting a recommended adjustment to at least one of a current inventory of the vehicle type and an on-order inventory of the vehicle type, thereby ensuring that a more desirable stock level is maintained for the at least one time period.

### CROSS-REFERENCE TO RELATED APPLICATION

This application claims priority to U.S. Provisional Application Ser. No. 61/719,987, filed Oct. 30, 2012.

### TECHNICAL FIELD

The present disclosure relates generally to vehicle inventory planning and more particularly to vehicle inventory tracking for car dealerships.

### BACKGROUND OF THE INVENTION

Car dealerships that sell new vehicles source their inventory from a car manufacturer, or from other dealerships. Typically, a dealer has access to a vehicle ordering system, which allows them to specify future vehicle orders, and to potentially make changes to vehicles that are already on order. The vehicle ordering system is commonly provided by the dealer's franchise. There are often constraints on the exact vehicles that can be ordered, based on availability from the manufacturer. In some cases, where the vehicles are being imported by ship or similar transport, the dealer may be given little or no choice and is notified which vehicles they have been allocated.

A given dealer may choose to trade a new vehicle that is on order, or is already in their inventory, with a new vehicle at another dealer. This typically happens if a customer requests a vehicle of a specification that is not in stock at a given dealer, but is in stock at an alternate dealer. In this case, the original dealer requests a vehicle “swap” or “trade” from the alternate dealer. If the swap is agreed to, the alternate dealer exchanges the vehicle in return for a different vehicle. In terms of volume of new vehicles sales by a dealer, vehicle swaps can represent 50% or more of all new vehicles sold.

The current system of new vehicle ordering is suboptimal because the dealer has little knowledge of what vehicle specifications customers will want to purchase in the future. The lead time from ordering to receipt of a vehicle at the dealership is typically six to twelve weeks, meaning the dealer has to attempt to predict what customers will be looking for at that time, as most consumers want buy a vehicle that is available immediately, and prefer not to wait the six to twelve weeks order time.

Customer preferences constantly vary in the new car industry, based on various factors, including but not limited to: economics (e.g. gas price changes), seasons (e.g. summer is popular for convertibles), new vehicle launches (e.g. a new model from a competitor), industry events (e.g. product recalls due to safety issues), major advertising or sponsorship activity (e.g. during major sporting events) and general changes in customer preferences.

As well as specifying the make and model (e.g. a Ford F150 or Toyota Camry), at the time of ordering a dealer will typically have to select the trim level (e.g. “LS”, “EX”, “Crew Cab” etc.), and potentially features such as engine size, transmission type, body style, interior and exterior features, color etc.

Prior to the advent of the internet, dealers had some sense of what people in their locality were looking to buy, based on the reality that people had to call or visit the dealer to find out if a preferred model and trim was in stock at that location. Dealers would be able to derive insights based on these inquiries as to whether their current inventory or order pipeline reflected local demand, and were better tuned to changes in local demand.

Today, potential new car customers can search for their preferred vehicle online without ever communicating their preferences to their local dealership. Instead they simply contact whichever dealership happens to already have a specific vehicle of interest in stock. Other dealers are oblivious to the missed sales opportunity. Current research also suggests that consumers who use the internet are also prepared to travel further distances to purchase their vehicle, which extends the competitive area that any given dealer can cover.

New car manufacturers and dealers often use a metric known as sales velocity, or simply “velocity” to help optimize new car production and inventory. Velocity is a measure of the average time that a given model is on the dealer lot, and therefore provides insight into what vehicles are currently selling fastest. Production and distribution are then typically increased for those particular vehicles, while production and distribution of slower selling models is typically reduced.

While using sales velocity improves the inventory mix to better meet demand, sales velocity suffers from being rearward looking. Sales velocity is only able to consider current and past sales demand, not future changes in demand. Also, sales velocity can only be applied to vehicles that are already in stock, and cannot consider customers who want to buy a model and trim combination that is not held in inventory at a particular location, or is only available in small quantities.

Further, reliance on sales velocity can lead to significant future over-supply of models that have a short term, or temporary, increase in sales interest. This type of short term increase occurs frequently for specialty models. This can lead to negative consequences when new production lines or factories are built for a model that appears to be taking off, but then fades from popularity.

New car dealerships can often amend their orders, up to a point in time prior to production, based upon what they believe future demand will be. Like the original order itself, these changes are usually based on an “educated guess” rather than anything measurable. This approach suffers from not being able to take into account consumer preferences that have not been communicated to the dealer, because many consumers have not yet been in direct contact with the dealer at this stage of the buying process.

The combination of these factors and metrics typically leads to sub-optimal production planning, dealer inventory allocation and ordering. By only looking at present sales, and guessing future trends, the industry often manufactures the wrong quantities of models and trims, and sub-optimally allocates the vehicles that have been built to dealers.

### SUMMARY OF THE INVENTION

Disclosed is a computer implemented method for optimizing dealer inventory including: determining at least one future purchase intention metric for a catchment area in which a dealer is located, determining expected future retail sales of a vehicle type based on the determined future purchase intention metric, comparing the expected future retail sales of the vehicle type to an expected inventory of the vehicle type for at least one time period, and outputting a recommended adjustment to at least one of a current inventory of the vehicle type and an on-order inventory of the vehicle type, thereby ensuring that a desired stock level is maintained for at least one time period.

### BRIEF DESCRIPTION OF THE DRAWINGS

FIG. 1 illustrates a process for adjusting a recommended inventory in response to a predicted future demand.

FIG. 2 illustrates a process for determining future purchase intention metrics of FIG. 1 in greater detail.

FIG. 3 illustrates a process for calculating a recommended inventory adjustment of FIG. 1 in greater detail.

FIG. 4 illustrates an example inventory adjustment table output by the process of FIG. 1.

FIG. 5 illustrates an example recommended inventory change chart output by the process of FIG. 1.

### DETAILED DESCRIPTION

For the purposes of the following description and claims the below definitions are used:

“Specified Vehicle” is an individual new car or truck for a specific Make (e.g. “Ford”), and Model (e.g. “Fusion”). Optionally, Specified vehicle can include Trim (e.g. “LS” or “EX”) and Features (e.g. engine size, transmission, 4×4 or 4×2. optional equipment, color etc.).

“Dealer Location” is a physical location where a franchised car dealership sells new cars and trucks to retail customers.

“Catchment Area” is a geographical area surrounding each dealer location where the majority of potential new car buyers live, work, or commute, defined by a number of zip codes or similar geographic boundary.

“Expected Future Retail Sales” is a metric for each Specified Vehicle for each dealer location based on the predicted new vehicle purchases from retail buyers within the Catchment Area, or close to the Catchment Area, for a specific future time period.

“Recommended Inventory Change” is a metric that indicates which specified vehicles should be ordered, due to being under stocked at that dealer location, and/or sold, or swapped to a different dealer when the opportunity arises due to being overstocked for that dealer location.

“Inventory Optimization metrics” is a collective term for the range of metrics using to optimize the mix of new vehicles held or on order by a dealer.

“Interstitial Data” refers to data that is generated between two stages of a purchase request process.

“Data Repository” refers a data storage component for storing data in the form of electronic reports, dashboards, or data visualizations such as charts.

The process described herein provides a means for new car dealers to better align the new vehicle models and trims they have in inventory with current local new car sales demand, and the vehicles they have on order for future delivery to be better aligned with future customer demand. Further, for the car manufacturers this process will better align production and new vehicle distribution to meet this local demand, and customers will have a greater chance of finding a vehicle closer to their ideal preference of model and trim.

It is in everyone's best interest to better match the production, inventory allocation and dealer ordering process to meet local demand. Dealers will sell more vehicles and/or can sell vehicles at less of a discount when the in stock vehicles are better matched to retail customer demand, as the dealers can spend less time and money convincing consumers to buy a different vehicle than one they actually want. The dealer can also spend less money on the transport associated with dealer vehicle swaps due to a decreased occurrence of dealer swaps. Car manufacturers benefit from increased sales over the less effective competition. Further, by ensuring that the correct mix of vehicles is delivered to each dealership, the dealerships have to offer less financial incentives and/or potentially reduce media expenditures required to sell their vehicles, because their franchised dealers would have a mix of vehicles, better reflecting a local customer interest.

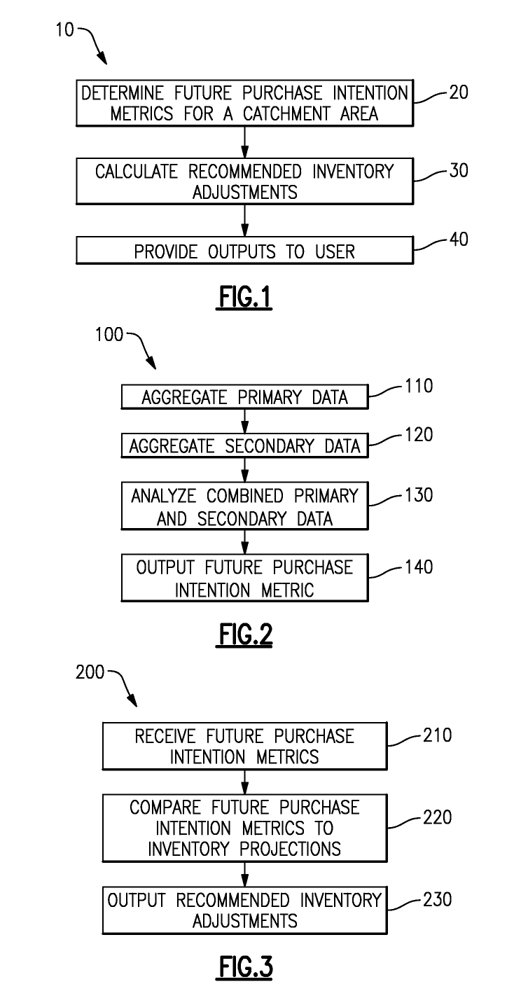

FIG. 1 illustrates a process 10 that enables car dealers, including dealer groups (a company that operates multiple individual dealer locations), and their franchised manufacturer to optimize the inventory of new cars available at each dealer location. This is achieved by determining future purchase intention metrics for the catchment area for each dealer location in a determine future purchase intention metrics for a catchment area step 20. The process 10 then calculates recommended inventory adjustments based on the determined future purchase intention metrics in a calculate recommended inventory adjustments step 30. Each of the steps 20, 30 is described in greater detail below.

Once the recommended inventory adjustments have been calculated, the process 10 provides outputs to the user in a provide outputs to user step 40. The outputs can include, but are not limited to, an expected future retail sales for each specified vehicle, a comparison between expected future retail sales to a current inventory for a given dealer location for each analyzed future time period, a comparison of the expected future retail sales to an order pipeline for the dealer location. Further still, the outputs can include a comparison between expected future retail sales and any combination of the above metrics. The outputs can be provided in any form and can be stored in a data repository.

In one example, the outputs are in the form of charts that allow a local dealer to manually adjust their vehicle orders to account for the future purchase intention metrics. In a second example, the output recommended inventory adjustments are provided to an automated vehicle ordering and swapping system that can utilize the recommended inventory adjustments of multiple aligned local dealers to optimize swapping and ordering for all of the dealers simultaneously. In the second example, the automated ordering or swapping system can be in the control of a contractor or consultant hired to perform the process described herein.

With further regard to the second example, dealer and manufacturer level access can be granted via an internet based portal including access to chart viewing and manipulation tools. Alternately, dealers and manufacturers can receive an offline electronic copy or a hard copy of the output charts.

With regards to the determine future purchase intention metrics step 20, the future purchase intention metrics are data metrics indicative of a market demand of the catchment area and are derived in whole or in part, from sources such as sales leads (referrals), web site information from automotive related website, including the price quote section, configurator section, and interstitial data. In some examples a source is any customer accessible automotive website. In some examples, the purchase intention metrics include data from four or more such sources combined together. Automotive websites can include third party sites, dealer websites, dealer group websites, the manufacturer's website, or any similar website. Further, the data used to derive the future purchase intention metrics can be collected in any number of known manners.

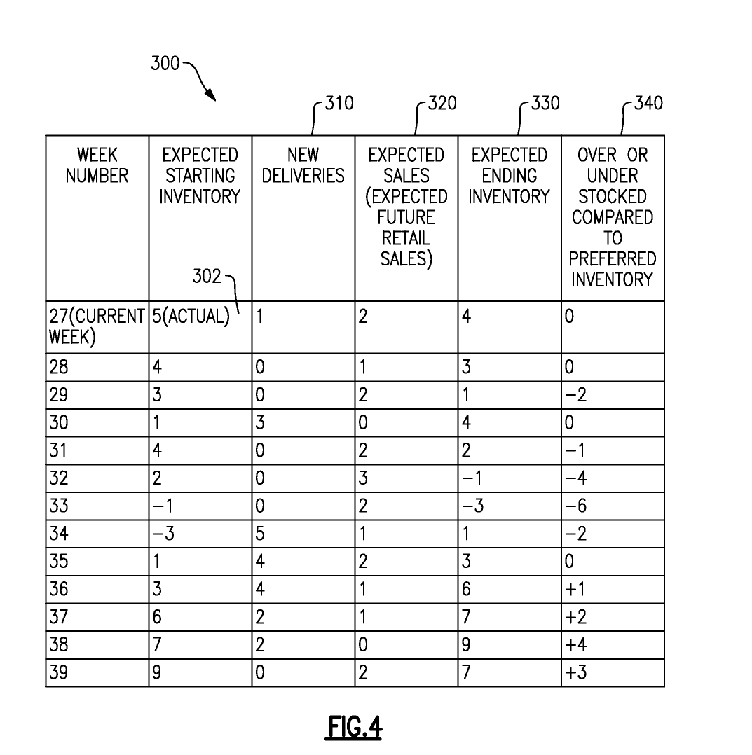

FIG. 2 illustrates the process 100 of determining the future purchase intention metrics of step 30 of FIG. 1 in greater detail.

Initially, a computer aggregates data from a primary data source in an aggregate primary data step 110. The primary data can be either automatically aggregated by the computer via ‘beacons’, webcrawlers, website log reporting, or any other automated system or entered manually into the computer by a user. Primary data sources can include current inventory data listing each specified vehicle currently in stock and available for purchase for the dealer location, current new vehicle order data for the dealer location, and each specified vehicle on order, together with an expected delivery date. Optionally, primary data sources can also include order status information, current vehicles in transit data for the dealer location, and historic local sales data and/or vehicle registration data, ideally at a zip code level for each specified vehicle.

In some examples, the primary data is data for a specific dealer location as well as data for other dealers in the broader local market area. For sales or registration data, this can be provided by the dealer location for their own sales, and/or by the relevant manufacturer or a data aggregation service for sales within the broader local market area. Registration data can also be collected from official sources, such as the DMV for each state. In one example, data from at least four primary data sources is aggregated in the aggregated primary data step 110.

Once the primary data sources have been aggregated, the computer aggregates data from secondary data sources in an optional aggregate secondary data step 120. Secondary data sources include vehicle production data listing capacity and planned production by make, model and trim for multiple future time periods, sales forecast data by make, model and trim features, new car sales velocity data showing the number of days each make, model and trim of inventory held in stock before being sold to a customer, and financial and lot-size constraints for each dealership.

Furthermore, in some embodiments, additional tertiary data sources can also be utilized. Economic factors including gas price, property sales, interest rates, unemployment levels, GDP etc. are included among the secondary data sources. Seasonal factors, including weather patterns and sales conversion patterns, that impact vehicle buying trends can be considered. Advertising and promotional activity data that is used to raise awareness and encourage consumers to consider purchasing a certain vehicle can be considered. Sales incentive data that is used to incent consumers to purchase a particular make and model of new vehicle can be considered. Competitive factors including new vehicle launches and incentive campaigns for competitive vehicles. As can be seen, any number of secondary and tertiary data sources that impact the purchasing trends of a local dealer area can be considered and impact on the recommended inventory adjustment.

In examples where data from the secondary data sources is utilized, the secondary data is merged with data from the primary data sources, and all of the data is processed to generate future purchase intention metrics in an analyze combined primary and secondary data step 130. In examples omitting secondary data, only the primary data is analyzed in the combined primary and secondary data step 130.

The data is processed using predictive modeling techniques including but not limited to regression techniques which include logistic regression, multinomial logistic regression, probit regression and logit modeling; time series models which include autoregressive and moving average models, ARMA, ARIMA, ARCH and vector autoregression models; decision Tree learning; multivariate adaptive regression splines; machine learning techniques; multilayer perceptron (MLP); radial basis functions, support vector machines; Bayesian mathematics including Naïve Bayes; factor analysis; nearest neighbors techniques; geospatial predictive modeling and state space modeling, or any combination of these techniques. The statistical processing allows the computer to generate predictions of future sales (expected future retail sales) based on the actual current retail customer interest being expressed in the primary data sources and the influencing factors of the secondary data sources. In one specific example, the data is processed using regression based on log transformation in order to minimize the frequency with which data must be input into the statistical model.

The utilization of historical sales data enables historic sales conversion trends, including seasonal adjustments to be taken into account. In other words, historical sales data allows sales conversion rates to be calculated by comparing historic purchase intention metrics and historic sales. While simple historic sales conversion rates can be used, the process of FIGS. 1-3 uses one or more advanced statistical and econometric modeling technique, such as the techniques listed above, to estimate expected future retail sales using the historic sales data, and optionally, one or more secondary data sources to further optimize new vehicle inventories.

Once the data has been processed, the computer outputs future purchase intention metrics in an output future purchase intention metrics step 140. The future purchase intention metrics can be any expected future data related to sales, orders or inventory. In a typical example, the future purchase metric is an expected future retail sales metric. The future purchase intention metrics are then utilized in a calculate recommended inventory adjustments step 30, illustrated in FIG. 1.

In some examples, the computer can also output a physical or electronic future purchase intention metrics database, and this database can be used in later iterations of the process 10, or in any other process utilizing future purchase intention metrics.

With regards to the calculate recommended inventory adjustments step 30, FIG. 3 illustrates the process for generating and outputting the inventory adjustments in greater detail. Initially, the process receives the future purchase intention metrics generated in the determine future purchase intention metrics for a catchment area step 20 in a receive future purchase intention metrics step 210. The computer then compares the future purchase intention metrics to inventory projections in a compare future purchase intention metrics to inventory projections step 220.

By way of example, if the future purchase intention metric is expected future sales, the process compares the expected future sales for each time period over a given duration against the expected inventory to generate an expected ending inventory at the end of each time period. The comparisons are compounded over given duration, and a total inventory overstock/understock can be seen. The process can then account for the new deliveries amounts step 310 and optimizes the expected overstock/understock and generates a recommended inventory adjustment chart.

The process then outputs recommended inventory adjustments in an output recommended inventory adjustments step 230. In one example, the recommended inventory adjustments are output as a chart that the local dealer can utilize to determine appropriate adjustments. In, another alternate example, the recommended inventory adjustments are output to an automatic inventory ordering system. The automatic inventory ordering system manages the inventory ordering and swapping of one or more local dealers. In the alternate example the one automatic inventory management system can then act on the recommended inventory adjustment to correct and optimize the inventory of the local dealer.

Following is a specific, non-limiting example output of the process illustrated in FIGS. 1-3.

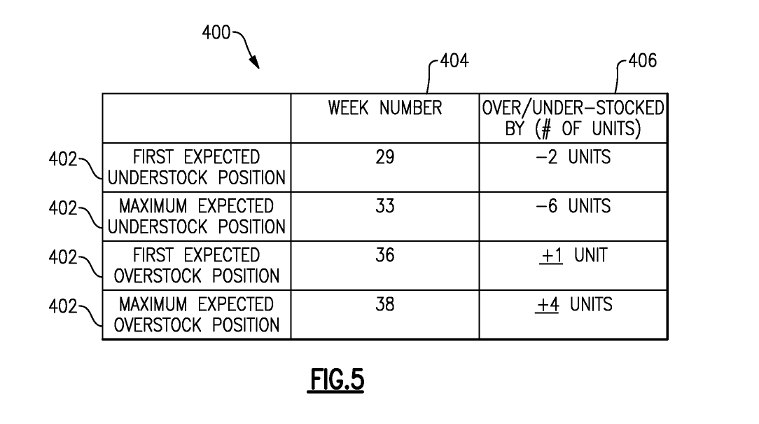

FIG. 4 illustrates an inventory adjustment table 300 for a Jeep Grand Cherokee at “Little Rock Autos”, a franchised Jeep Dealer in Arkansas, the inventory adjustments are shown on the inventory adjustment table 300, based on an actual current inventory 302 of five vehicles of that model type in Week 27. If desired, this could be for a specific vehicle type, such as the Grand Cherokee Laredo, and a specific feature such as the 4×4 version.)

In the illustrated example, the dealer has set an optimal inventory to between three and five vehicles for this specified vehicle.

Entries in a new deliveries 310 column are based on the schedule of planned factory orders and in transit vehicles that have already been allocated by the manufacturer. Expected sales 320 are derived using the above described predictive modeling techniques factoring in future purchase intention metrics as described above with regards to FIGS. 1 and 2. In some examples, the future purchase intention metrics are derived using predictive modeling techniques including but not limited to regression techniques which include logistic regression, multinomial logistic regression, probit regression and logit modeling; time series models which include autoregressive and moving average models, ARMA, ARIMA, ARCH and vector autoregression models; decision Tree learning; multivariate adaptive regression splines; machine learning techniques; multilayer perceptron (MLP); radial basis functions, support vector machines; Bayesian mathematics including Naïve Bayes; factor analysis; nearest neighbors techniques; geospatial predictive modeling and state space modeling or similar techniques. An expected ending inventory 330 column shows the expected change in inventory during the week in question as a result of the expected sales. The expected ending inventory 330 column can have negative values, which highlights an under-stocking scenario. In the case of an under-stocking scenario, the dealer loses sales to prospective customers unless additional stock can be ordered, or swapped with another dealer.

For this Arkansas dealer, the preferred inventory for the Grand Cherokee is set to no less than three units on hand, and no more than five units at any time. An overstock/understock column 340 highlights which weeks are expect to be out of the preferred inventory range, and by how many units. In some examples, the dealer can change the preferred values via a software interface. In alternate examples, the dealer contracts a third party company to perform the analysis on the dealer's behalf, and the third party company inputs the dealers preferred range. Alternatively, the preferred values can be computer generated based on an optimization model that recommends stock levels. The input may be a number of vehicles as in this example, or may be based on the financial value of the vehicles held in stock, or the number of days of supply held in stock.

For the above example, a recommended inventory change 400 is illustrated in FIG. 5 and summarizes the expected inventory position. The recommended inventory change 400 informs the dealer and/or manufacturer of future under/overstock conditions. This information allows the dealer/manufacturer to determine what actions to take now, to prevent future inventory issues.

The recommended inventory change 400 chart provides multiple data points 402, with each data point 402 indicating a week 404 where the data point 402 is predicted to occur. The recommended inventory chart 400 further provides the total under/overstocks 406 represented by the identified data point 402. Upon receipt of the recommended inventory change 400 chart, the dealer and/or manufacturer can adjust the vehicles being manufactured/ordered now, and thereby compensate for the predicted future under/overstock 406.

Generation of the inventory adjustment table 300 (shown in FIG. 4) further allows a comparison of a given dealer location under/over stock position to be compared with other local, regional and national dealers. For example, it may be that all local dealers are expected to be under-stocked of Jeep Grand Cherokees from Weeks 29 to 33 due to under production from the factory. Or, however, it may be specific to this dealer, or dealers within a locality or region, meaning that it would be possible to switch new vehicle deliveries, or swap vehicles already at a dealer with other dealers to better balance overall inventory across all dealers. Alternatively, a local dealer can use this information to achieve a competitive advantage over other dealers within the same catchment area.

The above described process further enables recommended vehicle swaps. In some examples, a computer system can integrate and compare recommended inventory changes from multiple dealer locations. Based on this comparison, the computer system can automatically recommend specific vehicle swaps that are beneficial to both dealers, or to multiple dealers. This comparison can be for a specific dealer location, for groups of dealers, or for the manufacturer.

While all the primary data sources listed combined provide an optimal solution, partial data still provides beneficial forward looking metrics under the above described processes. For example if future vehicle order data is not available, it would still be possible to create a listing of recommended orders from the current inventory data and the Purchase Intention metrics.

Although an embodiment of this invention has been disclosed, a worker of ordinary skill in this art would recognize that certain modifications would come within the scope of this invention. For that reason, the following claims should be studied to determine the true scope and content of this invention.

1. A computer implemented method for optimizing dealer inventory comprising:
determining at least one future purchase intention metric for a catchment area in which a dealer is located;
determining expected future retail sales of a vehicle type based on the determined future purchase intention metric;
comparing the expected future retail sales of the vehicle type to an expected inventory of the vehicle type for at least one time period; and
outputting a recommended adjustment to at least one of a current inventory of the vehicle type and an on-order inventory of the vehicle type, thereby ensuring that a desired stock level is maintained for at least one time period.

2. The method of claim 1, wherein the step of determining at least one future purchase intention metric for the catchment area comprises aggregating data from at least one primary source, and wherein said at least one primary source comprises at least one of a sales referral data source, an automated price quote web site, a vehicle configurator, and interstitial data from a purchase request process.

3. The method of claim 2, wherein the future purchase metrics are determined via a statistical analysis of at least one of the primary sources, and wherein the statistical analysis utilizes at least one analysis technique selected from the list of logistic regression, multinomial logistic regression, probit regression and logit modeling, time series models which include autoregressive and moving average models, ARMA, ARIMA, ARCH and vector autoregression models, decision Tree learning, multivariate adaptive regression splines, machine learning techniques, multilayer perceptron (MLP), radial basis functions, support vector machines, Bayesian mathematics including Naïve Bayes, factor analysis, nearest neighbors techniques, geospatial predictive modeling, regression based on log transformations and state space modeling.

4. The method of claim 2, wherein the step of determining at least one future purchase intention metric further comprises aggregating data from at least one secondary source.

5. The method of claim 4, wherein said at least one secondary source is at least one of a planned production of the vehicle type, a sales forecast, a new car sales velocity, a financial constraint of the vehicle, and a volume constraint of the dealer.

6. The method of claim 4, wherein said at least one secondary source is at least one abstract secondary source including at least one of a seasonal factor, an economic factor, promotional activity, and a sales incentive factor.

7. The method of claim 1, wherein the step of determining expected future retail sales based on the determined purchase intention metrics comprises analyzing the determined purchase intention metrics using at least one statistical analysis technique selected from the list of logistic regression, multinomial logistic regression, probit regression and logit modeling, time series models which include autoregressive and moving average models, ARMA, ARIMA, ARCH and vector autoregression models, decision Tree learning; multivariate adaptive regression splines, machine learning techniques; multilayer perceptron (MLP), radial basis functions, support vector machines, Bayesian mathematics including Naïve Bayes, factor analysis, nearest neighbors techniques, geospatial predictive modeling, regression based on log transformations and state space modeling.

8. The method of claim 7, wherein the step of determining expected future retail sales based on the determined purchase intention metrics comprises analyzing the determined purchase intention metrics uses a combination of at least two statistical analysis techniques selected from the list of logistic regression, multinomial logistic regression, probit regression and logit modeling, time series models which include autoregressive and moving average models, ARMA, ARIMA, ARCH and vector autoregression models, decision Tree learning; multivariate adaptive regression splines; machine learning techniques; multilayer perceptron (MLP), radial basis functions, support vector machines, Bayesian mathematics including Naïve Bayes, factor analysis, nearest neighbors techniques, geospatial predictive modeling, regression based on log transformations and state space modeling.

9. The method of claim 7, wherein said at least one statistical analysis technique comprises regression based on log transformations.

10. The method of claim 1, wherein the step of comparing the expected future retail sales of the vehicle type to an expected inventory of the vehicle type for at least one time period further comprises comparing an expected local inventory of the vehicle type in said time period to an expected total inventory of the vehicle type of all dealerships within the catchment area.

11. The method of claim 1, further comprising the step of outputting a comparison comparing the expected future retail sales of the vehicle to an expected inventory of the vehicle for at least one time period, and storing the output in a data repository.

12. The method of claim 1, wherein said step of outputting a recommended adjustment to at least one of a current inventory of the vehicle type and an on-order inventory of the vehicle type, thereby ensuring that a desired stock level is maintained for at least one time period further comprises outputting a recommended vehicle swap.

13. The method of claim 1, wherein said step of outputting a recommended adjustment to at least one of a current inventory of the vehicle type and an on-order inventory of the vehicle type comprises automatically altering a number of vehicles on order from a manufacturer.

14. The method of claim 1, wherein said future purchase intention metrics are data metrics indicative of a market demand of the catchment area, and wherein said future purchase intention metrics are derived at least in part from data sources indicative of customers' intent to purchase a vehicle.
